(19) United States
(12) Patent Application Publication
(10) Pub. No.: US 2003/0171759 A1
(43) Pub. Date: Sep. 11, 2003

(54) Medical clips

(76) Inventors: Kenneth George Sadler, West Sussex (GB); Marcus Filshie, Nottingham (GB); Paul Brown, Nottingham (GB)

Correspondence Address: SALTER & MICHAELSON, THE HERITAGE BUILDING, 321 SOUTH MAIN STREET, PROVIDENCE, RI, 029037128

(21) Appl. No.: 10/276,731

(22) PCT Filed: May 17, 2001
(86) PCT No.: PCT/GB01/02193

(30) Foreign Application Priority Data
May 17, 2000 (GB) 0011764.8

(51) Int. Cl. A61D 1/06

(52) U.S. Cl. 606/135

(57) ABSTRACT

A clip for sexual sterilization is provided. The clip includes resilient upper and a lower jaw members, and may be readily assembled by means of cooperating aperture and finger members on the upper and lower jaws.

The present invention relates to medical clips, and more particularly to clips suitable for sexual sterilisation devices which may be used as a sexual sterilisation clip adapted to be clamped on a Fallopian tube or vas deferens to effect occlusion. Hereinafter the clip will be referred to as a sterilisation clip, but it is to be understood that the clip may be used for other purposes.

It is known for sterilisation clips to be made of a unitary construction using non-metallic materials. For example, in GB 2285582 (Femcare (Cyprus) Ltd, there is described a clip of unitary construction having an additional silicone lining, which comprises an upper and a lower jaw connected by a first hinge and having an internal silicone lining, the upper and lower jaws having opposite the first hinge a cooperating latch means comprised of interlocking members in the jaws, which serve to secure the upper and lower jaws in a closed position. This embodiment of the clip also has on the lower jaw proximate the cooperating latch means a second hinge which enables the latch end of the lower jaw to pivot, thereby facilitating closure of the clip. It is said in this publication that this clip may be made of plastics materials

Advantages of the present medical clip of the invention include that the clip may be made relatively cheaply and of plastics materials. It may also be made in such a manner that the manufacturing tolerances in producing the clip are larger. A further advantageous aspect of the invention is that it may be possible to produce clips which are relatively small, yet still function satisfactorily.

U.S. Pat. No. 5,938,666 shows a plastic clip with a latching mechanism for clamping umbilical cords.

EP-A2-220,643 shows a hemostatic surgical clip with a latching mechanism.

According to a first aspect, there is provided a medical clip for use as a sexual sterilization clip as claimed in claim 1.

Preferably, at least one of the jaws and preferably both the upper and lower jaws of the clip are lined with an elastomeric lining, such as silicone rubber.

Preferably, the upper jaw is preformed as a bowed member, and the lower jaw is preformed to be substantially straight. However, it is also preferred that the upper jaw is shorter than the upper jaw, such that when the clip is put in the closed position, the latch means on the lower jaw (and with it the end of the lower jaw remote from the hinge) is drawn towards the latch means on the upper jaw in such a manner that not only is the upper jaw caused to straighten somewhat from its preformed bowed configuration (for example on the application of pressure during the closing procedure, before the latching means cooperate) but also that the relatively straight lower jaw may be caused to bow.

Embodiments of the invention have been found to be advantageous over prior designs of clips. In particular, and in contrast to prior clips, the sealing force of the clip relies not only on the relative pressure of the clip jaws against each other such pressure being applied via the intermediary of the elastomeric preferably silicone rubber lining, but also the resiliency of both the jaws of the clip. In more detail, when the jaws of the clip are closed, the design of clip makes use of the resilient nature of the jaws of the clip in such a way that the energy stored in the jaws when the clip is closed is brought to bear on the vessel being sealed. This is in contrast to prior clips, in which at least one jaw of the clip is not deformable under the forces brought to bear in the usage and sealing of the clip. The result is that the clip may be able to bring to bear greater sealing pressure on the vessel being sealed in use, and hence may enable the clip to be manufactured from different (eg plastics) materials compared to previously, but may also be made slightly smaller. This second feature is advantageous, since it provides the opportunity for delivery and use of the clip from relatively small diameter surgical applicators (see for example our application GB 0006354.5). As the surgical applicator may be made of smaller diameter, this may improve the manipulability of the surgical applicator, and also should minimise the size of any surgical incisions which need to be made.

As the clip relies at least in part for its sealing effect on the resilience of the jaws, this may facilitate the relatively simple and low cost manufacture of the clip from plastics materials, although the clip may be still be made from metals such as titanium.

The invention will now be further described by way of example only with reference to the accompanying drawings in which:

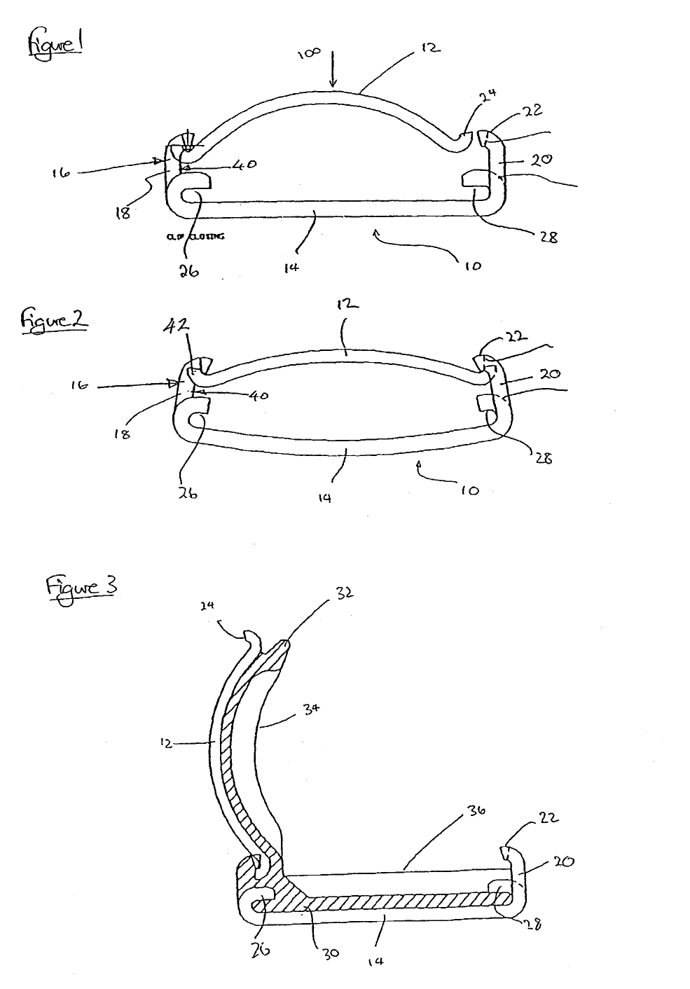

FIG. 1 shows in cross section a side elevation of a clip according to the invention in a partially closed configuration;

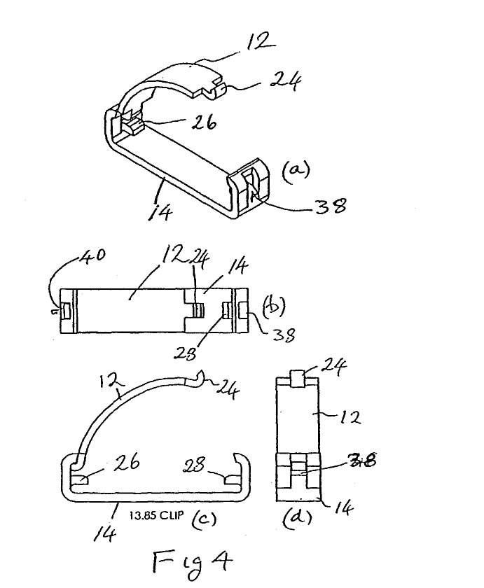

FIG. 2 shows the clip of FIG. 1 in the fully closed configuration;

FIG. 3 shows a partial cross sectional view of the clip of FIGS. 1 and 2 in the fully open configuration with a silicone rubber lining attached,

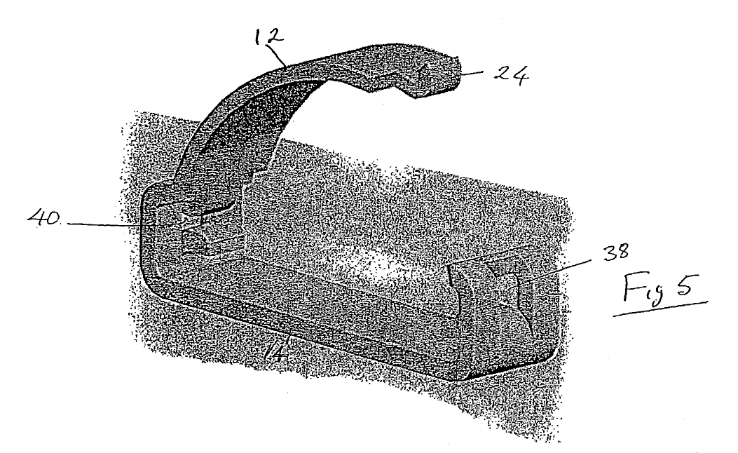

FIG. 4 shows a clip according to the present invention without elastomeric lining (a) in perspective view from the front end (end opposite the hinge), (b) in a plan view, (c) in a side view and (d) in a front end view,

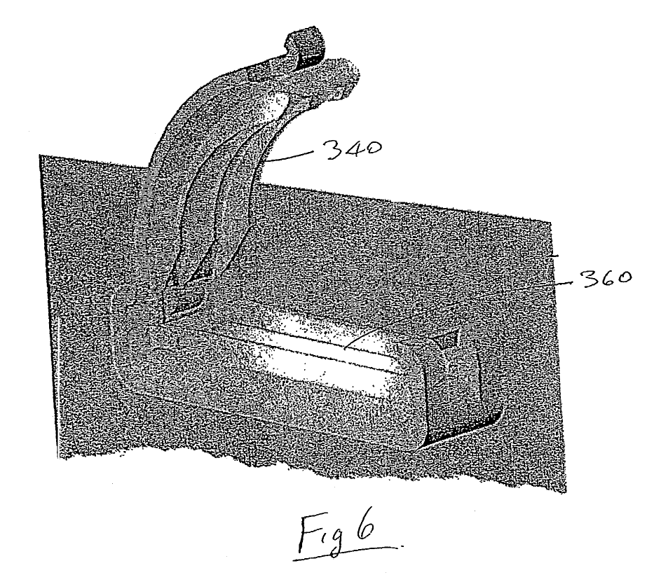

FIG. 5 shows a perspective view of a practical embodiment of the clip shown in FIG. 6 with no elastomeric lining and,

FIG. 6 shows the clip of FIG. 5 with an elastomeric, preferably silicone rubber lining.

Referring to FIG. 1, the clip 10 comprises an upper jaw 12 and a lower jaw 14 joined together at a hinge end 16. Lower jaw 14 comprises a hinge leg 18 which extends perpendicularly from the lower jaw 14 at the hinge end.

Clip 10 also has a latch leg 20 which extends generally perpendicularly from lower jaw 14 at the end remote from the hinge end. Latch leg 20 is curved at its free end 22, and has an aperture 38 therein indicated by dotted lines 201,202 which acts as a latching means for detaining the latching part of upper jaw 12. Upper jaw 12 likewise has a hooked portion 24.

Lower jaw 14 also has attached thereto retention fingers 26, 28 to consist in holding and retaining an elastomeric insert (not shown), which acts as a lining preferably for both upper and lower jaws which may be detained in the hollow located in free end 22 of latch (eg 20 when in the closed position. The elastomeric lining is shown by way of example in FIGS. 2 and 6 and is preferably glued to the jaws by a suitable adhesive.

The hinge structure comprises an aperture 40 formed in the lower jaw 14 in its generally perpendicular hinge leg 18. This aperture 40 cooperates with a hinge end hook portion 42 formed on the upper jaw to form the hinge.

The hinge may therefore be assembled by insertion of the hook portion 42 into the aperture 40. A hinge pin is not required since in the applicator described in the above-mentioned GB patent application the clip cannot be opened sufficiently to disengage the hook portion 42 and aperture 40 in normal operations. The silicone rubber lining 30 (see FIG. 3) will also assist in retaining the hinge mechanism, preventing accidental separation of the upper and lower jaws. Once the clip is closed (locked) the hook member 42 will be firmly lodged within the aperture 40 and thus the clip will not be able to be dislodged by internal or external pressure.

As can be seen from FIG. 1, prior to closing upper jaw 12 is relatively bowed, whereas lower jaw 14 is straight (though lower jaw 14 could just as easily be slightly bowed). However, when sufficient force is applied in the direction of arrow 100, acting against the resiliency of the silicone elastomer insert, (not shown) hooked portion 24 of upper jaw 12 will engage with and be retained by the aperture 201,202 in free end 22 of latch leg 20. At the same time, lower jaw 14 may be caused to bow as shown in FIG. 2, with the consequence that free end 22 of latch leg 20 is caused to move closer to hooked portion 24, thereby facilitating latching. Upper jaw 12 and lower jaw 14 are dimensioned and configured, as well as manufactured from suitable material so as to provide the resilient behaviour described above. Provided upper jaw 12 has appropriate malleable properties, it may be deformed (ie flattened) during the closing operation to assist in preventing future undesired opening of the clip.

FIG. 3 shows an embodiment of clip as shown in FIGS. 1 and 2, only with a preformed elastomeric insert 30. Preferably the insert will be silicone rubber Insert 30 assists in conveying appropriate pressure to the clamped vessels, as well as providing a return force on the closed clip so as to prevent inadvertent opening of the clip. In a preferred embodiment the elastomeric insert generally extends along the opposing inner faces of upper jaw 12 and lower jaw 14, and has cooperating interlocking faces 34, 36, but in addition is configured to extend around the hinge means in such a way as to firstly provide resistance to opening or closing as desired and secondly to ensure that there is no egress for the fallopian tube at the hinge end. Though not preferred, it is possible to have an elastomeric lining on only one flow side of the clip but this must perform both first and second functions as described.

In addition, insert 30 preferably has a lip 32 which in closing is detained between retention finger 28 and free end 32, and acts resiliently on the underside of hooked portion 24 to further urge it into the hollow in free end 22, and prevent inadvertent opening.

With reference to FIG. 4 the clip is shown in a perspective view illustrating the aperture 38 at the latch end i.e. distal end from the hinge.

In FIG. 3(b) a plan view shows aperture 38 and 40 at the hinge end.

FIG. 5 shows a more practical embodiment of the clip without the elastomeric lining. The apertures 38,40 are clearly shown.

FIG. 6 shows the clip of FIG. 5 with a first design of elastomeric lining. The cooperating faces 34,36 comprise a plurality of longitudinal ribs 340, 360.

In this case the linings 34,36 are separate and do not extend around the hinge as in FIG. 3. The deep ribs 340 and 360, however, serve to hold the fallopian tube, vas deferens on other vessel to be occluded down into the bottom jaw of the clip, thereby ensuring that the tube cannot migrate towards the hinge aperture 40. Thus, the tube or vessel will remain occluded.

1. A medical clip for use as a sexual sterilisation clip having a resilient lower jaw member and a resilient upper jaw member hingedly connected at one end to the lower jaw member, the clip having cooperating latch means which may secure the clip in a closed position, the upper and lower jaws being convexly bowed when the clip is in the closed position in which said cooperating latch means comprises a hooked portion formed integrally with said upper jaw member at an end of said upper jaw, opposite to said hinge of said upper jaw and in which said lower jaw member is formed with an aperture at a distal end of said lower jaw member, opposite to said hinge and in which said hook member is dimensioned to cooperate with said aperture to form said latch means to latch, said clip in a closed position and in which said lower jaw is formed with a finger adjacent to said aperture, said finger extending from said aperture towards said hinge end of said lower jaw and being integrally situated within said lower jaw, said finger being dimensioned to cooperate with said hooked portion of said upper jaw to guide said hooked portion of said upper jaw through said aperture in said lower jaw during closure of said clip.

2. A medical clip as claimed in claim 1 in which at least one of said jaw members is lined with an elastomeric lining material.

3. A medical clip as claimed in claim 2 in which said elastomeric lining material is silicone rubber.

4. A medical clip as claimed in any one of claims 2 to 3 in which said elastomeric lining comprises a ribbed structure, said ribs extending longitudinally along the jaw length of the clip on said upper and/or lower jaws.

5. A medical clip as claimed in any one of claims 1 to 4 in which said hinge comprises a hinge aperture formed in said lower jaw member and a hinge hook portion formed in said upper jaw member, said hinge hooked portion being dimensioned to pass through said hinge aperture to form said hinge.

6. A medical clip as claimed in claim 5 in which said lower jaw is formed with a further finger adjacent to said hinge aperture, said further finger extending from said hinge end of said lower jaw towards said distal end and being integrally situated within said lower jaw, said finger being dimensioned to co-operate with said hinge hook portion to assist in retaining said hinge hook portion within said aperture.
